(19) United States
(12) Patent Application Publication
(10) Pub. No.: US 2017/0230784 A1
(43) Pub. Date: Aug. 10, 2017

(54) METHOD AND APPARATUS FOR TRANSMITTING AND RECEIVING A DATA IN A MESH NETWORK USING BLUETOOTH

(71) Applicant: LG ELECTRONICS INC., Seoul (KR)

(72) Inventors: Younghwan KWON, Seoul (KR); Jingu CHOI, Seoul (KR); Taeyoung SONG, Seoul (KR)

(73) Assignee: LG ELECTRONICS INC., Seoul (KR)

(21) Appl. No.: 15/424,376

(22) Filed: Feb. 3, 2017

Related U.S. Application Data
(60) Provisional application No. 62/290,955, filed on Feb. 4, 2016.

(51) Int. Cl. H04W 4/00; H04W 52/02; H04L 29/12

(52) U.S. Cl. CPC H04W 4/008; H04L 61/157; H04W 52/0229; H04W 84/18

(57) ABSTRACT

The present invention provides a method for transmitting and receiving data by a first node in a Bluetooth mesh network. The first node establishes a first specific relationship with a first relay node, transmits, to the first relay node, a first message including a network address of a second relay node that has established a second specific relationship with the first node before the first specific relationship is established, and receives at least one message stored in the second relay node from the first relay node in an active state.

### CROSS-REFERENCE TO RELATED APPLICATION

This application priority to Provisional Application No. 62/290,955 filed on 4 Feb. 2016 in the US the entire contents of which are hereby incorporated by reference in their entirety.

### BACKGROUND OF THE INVENTION

Field of the Invention

The present invention relates to a method and apparatus for transmitting and receiving data in a mesh network using Bluetooth, which is a short-range communication technology, in a wireless communication system and, particularly, to a method and apparatus for receiving data by a node through a relay node in a Bluetooth mesh network.

Discussion of the Related Art

Bluetooth is a short-range wireless technology standard that can wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### SUMMARY OF THE INVENTION

An object of the present invention is to provide a method and apparatus for transmitting and receiving data using Bluetooth LE (Low Energy) technology.

In addition, an object of the present invention is to provide a method and apparatus for forming a mesh network using Bluetooth LE.

Furthermore, an object of the present invention is to provide a method and apparatus through which a node transmits and receives a message through a relay node in a Bluetooth LE mesh network.

Moreover, an object of the present invention is to provide a method and apparatus through which a relay node stores a message transmitted to an edge node while the edge node is in a low energy state in a Bluetooth LE mesh network.

In addition, an object of the present invention is to provide a method and apparatus through which a current relay node receives a message transmitted to an edge node and stored in a previous relay node from the previous relay node and transmits the message to the edge node when the location of the edge node is changed while the edge node is in a low energy state in a Bluetooth LE mesh network.

Further, an object of the present invention is to provide a method and apparatus for deleting a message which has been stored in a previous relay node and transmitted to an edge node when the location of the edge node is changed in a Bluetooth LE mesh network.

Technical tasks obtainable from the present invention are non-limited by the above-mentioned technical task and other unmentioned technical tasks can be clearly understood from the following description by those having ordinary skill in the technical field to which the present invention pertains

The present invention provides a method for transmitting and receiving data by a first node in a Bluetooth mesh network to solve the aforementioned problems.

The present invention provides a method including: establishing a first specific relationship with a first relay node, wherein the first specific relationship indicates a relationship in which the first relay node receives and stores messages transmitted to the first node when the first node is in a low power state; transmitting, to the first relay node, a first message including a network address of a second relay node that has established a second specific relationship with the first node before the first specific relationship is established, wherein the second specific relationship indicates a relationship in which the second relay node receives and stores messages transmitted to the first node when the first node is in the lower power state; and receiving at least one message stored in the second relay node from the first relay node in an active state, wherein the at least one message is a message stored in the second relay node while the first node maintains the second specific relationship with the second relay node.

A destination of the at least one message may be set to the first node.

The establishing of the first specific relationship may include: transmitting a request message for requesting establishment of the first specific relationship to the first relay node and neighbor relay nodes; receiving, from the first relay node, a response message indicating that the first relay node among the first relay node and the neighbor relay nodes has been determined as a node for establishing the first specific relationship; and transmitting, to the first relay node, an acknowledgement message including a group address of a group including the first node.

The method may further include: transmitting, to the first relay node, a request message for requesting transmission of one or more messages having the address of the first node as a destination address and stored in the first relay node in an active state; and receiving the one or more messages from the first relay node.

The request message may include an update time parameter indicating duration of the active state.

The low power state may indicate a state in which the first node does not transmit and receive messages and the active state indicates a state in which the first node transmits and receives message.

The first node may periodically switch from the low power state to the active state.

In addition, the present invention provides a method including: establishing a first specific relationship with a first node, wherein the first specific relationship indicates a relationship in which a first relay node receives and stores messages transmitted to the first node when the first node is in a low power state; receiving, from the first node, a first message including a first network address of a second relay node that has established a second specific relationship with the first node before the first specific relationship is established, wherein the second specific relationship indicates a relationship in which the second relay node receives and stores messages transmitted to the first node when the first node is in the lower power state; transmitting, to the second relay node, a request message for requesting transmission and deletion of at least one message stored in the second relay node; receiving the at least one message from the second relay node; and transmitting the at least one message to the first node, wherein the request message includes an identifier for identifying the first node and a second network address of the first relay node, and a destination of the at least one message is set to the address of the first node.

The establishing of the first specific relationship may include: receiving, from the first node, a first request message for requesting establishment of the first specific relationship; transmitting a second message to neighbor relay nodes adjacent to the first node, wherein the second message includes first parameter information for determining a node for establishing the first specific relationship; receiving a third message from each of the neighbor relay nodes, wherein the third message includes second parameter information for determining the node for establishing the first specific relationship; comparing the first parameter information with the second parameter information; transmitting, to the first node, a response message indicating that the first relay node is determined to be the node for establishing the first specific relationship from among the first relay node and the neighbor relay nodes when the first relay node is determined to be the node for establishing the first specific relationship as a comparison result; and receiving, from the first node, an acknowledgement message including a group address of a group including the first node.

The first parameter information may include at least one of first cache information indicating an available cache of the first relay node, a first received signal strength indication (RSSI) of the first relay node and a first time parameter indicating a time for which messages are transmittable from the first relay node to the first node, and wherein the second parameter information includes at least one of second cache information indicating an available cache of each of the neighbor relay nodes, a second RSSI of each of the neighbor relay nodes and a second time parameter indicating a time for which messages are transmittable from each of the neighbor relay nodes to the first node.

The response message may include the first parameter information.

The method may further include: receiving one or more messages transmitted to the first node when the first node is in a low power state; storing the one or more messages; receiving, from the first node, a second request message for requesting transmission of the one or more messages; transmitting the one or more messages to the first node; and deleting the one or more messages.

Furthermore, the present invention provides a device including: a communication unit for communicating with the outside in a wireless or wired manner; and a processor functionally connected with the communication unit, wherein the processor is configured: to establish a first specific relationship with a first relay node, wherein the first specific relationship indicates a relationship in which the first relay node receives and stores messages transmitted to the first node when the first node is in a low power state; to transmit, to the first relay node, a first message including a network address of a second relay node that has established a second specific relationship with the first node before the first specific relationship is established, wherein the second specific relationship indicates a relationship in which the second relay node receives and stores messages transmitted to the first node when the first node is in the lower power state; and to receive at least one message stored in the second relay node from the first relay node in an active state, wherein the at least one message is a message stored in the second relay node while the first node maintains the second specific relationship with the second relay node.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram illustrating an example of a wireless communication system using Bluetooth LE technology to which the present invention is applicable;

FIG. 2 is block diagrams of devices to which the present invention is applicable;

FIG. 3 is a schematic diagram illustrating an example of a Bluetooth mesh network to which the present invention is applicable;

FIG. 4 illustrates an example of a protocol stack of the Bluetooth mesh network to which the present invention is applicable;

FIG. 5 is a flowchart illustrating an example of a method through which a device joins a Bluetooth mesh network to which the present invention is applicable;

FIG. 6 is a flowchart illustrating an example of a method for forming a friendship relationship between an edge node and a relay node in a Bluetooth mesh network to which the present invention is applicable;

FIG. 7 is a flowchart illustrating an example of a method for transmitting and receiving messages between an edge node and a relay node having a friendship relationship therebetween to which the present invention is applicable;

FIG. 8 illustrates an example in which an edge node in a friendship relationship in a Bluetooth mesh network moves to which the present invention is applicable;

FIG. 9 illustrates an example of a method through which an edge node having a friendship relationship in a Bluetooth mesh network transmits/receives messages to/from a relay node having a new friendship relationship with the edge node to which the present invention is applicable;

FIGS. 10 and 11 are flowcharts illustrating an example of a method through which a node receives a message, which is transmitted when the node is in a low power state, later through a relay node in a Bluetooth mesh network to which the present invention is applicable; and

FIG. 12 is a flowchart illustrating an example of a method through which a relay node stores messages transmitted to a node when the node is in a low power state in a Bluetooth mesh network to which the present invention is applicable.

### DETAILED DESCRIPTION OF THE EMBODIMENTS

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

Hereinafter, the terms, “node” and “device” are given or mixed only by considering the convenience of description, and do not have distinguished meanings or roles in themselves.

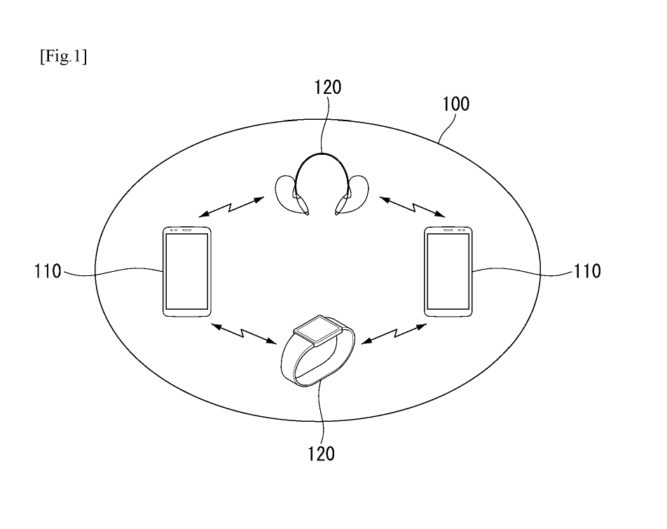

FIG. 1 is a schematic diagram illustrating an example of a wireless communication system using a Bluetooth LE technology to which the present invention is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

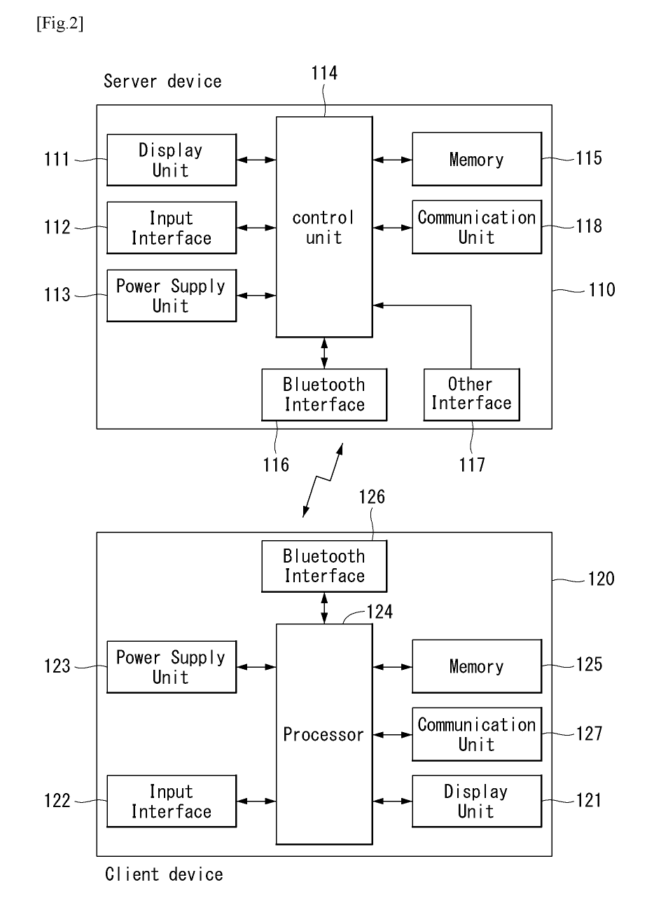

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

FIG. 2 is block diagrams of devices to which the present invention is applicable.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message there through.

The processors 114 and 124 may also be termed a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules which receive external power and internal power and provide power necessary for operation of components under the control of the processor.

As described above, BLE technology has a small duty cycle and can remarkably reduce power consumption through a low data rate.

The input units 112 and 122 refer to modules which provide user input through a screen button, for example, to the controller such that the user can control device operation.

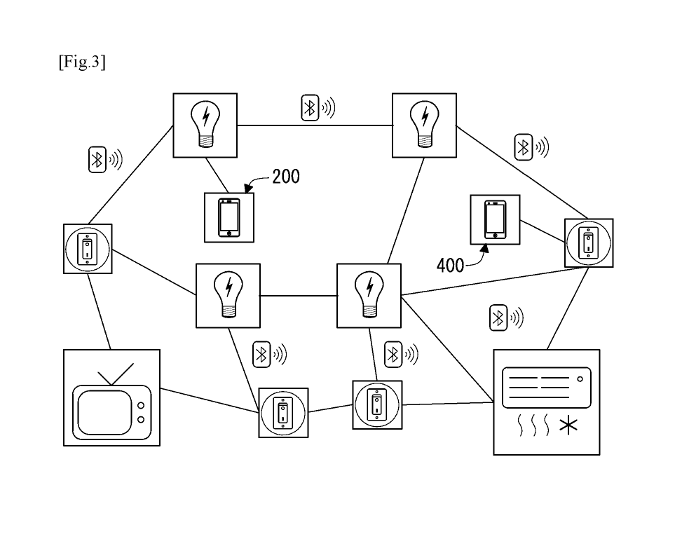

FIG. 3 is a schematic diagram illustrating an example of a Bluetooth mesh network to which the present invention is applicable.

As illustrated in FIG. 3, a mesh network refers to a network in which multiple devices are connected like a mesh through Bluetooth to transmit and receive data.

A Bluetooth mesh network is made up of relay nodes that relay messages between a source device 200 that sends data and a destination device 400 that receives data.

Alternatively, the Bluetooth mesh network may include edge nodes 200 and 400 and relay nodes.

As used herein, the term “node” refers to devices that form a mesh network, and the terms “node” and “device” can be used together.

Each node has a message cache of recently received messages. If a received message is already in the message cache, this message is not relayed any longer.

However, if the received message is not in the message cache, the message is relayed and stored in the message cache.

An edge node usually gets its power from a battery, and is in sleep state at normal times and may wake up for interaction or periodically.

The edge node may handle a received message if the following conditions are met:

The message is not in the message cache.

The message is authenticated by a known network key.

The destination of the message is the edge node's unicast address, a broadcast address or group address to which the edge node belongs.

A relay node is usually a device that draws main power, which is always awake and transmits received data for other nodes.

The relay node may retransmit a received message to other nodes if the following conditions are met:

The message is not in the message cache.

The message is authenticated by a known network key.

The field (e.g., relay value) indicating whether to relay the message has a value that permits relaying.

The destination address is not a unicast address assigned for the relay node.

Bluetooth mesh networks may use either a flooding technique or a routing technique, depending on how relay nodes transmit data.

In the routing technique, the source device 200 sends a message to a particular relay node, and the particular relay node, upon receiving the message, transmits the message based on information on another relay node or the destination device 400 to which the message is to be retransmitted.

The routing technique uses a broadcasting channel or point-to-point connection so as to receive and retransmit messages.

A routing device that receives a message using the routing technique determines the best routing route(s) along which the message is to be sent to an intermediate device or destination device, and decides which route to take to send the message based on a determined routing table.

With routing, however, messages need to maintain their routing tables when they are sent. Thus, the routing technique becomes more complex and requires more memory as the number of messages increase. Also, the routing technique is less dynamic and more difficult to implement than the flooding technique, but offers good extensibility.

The flooding technique refers to a technique in which relay nodes receive a message and transmit it over the air via radio waves having the characteristic of propagating into the air in all directions.

That is, the source device 200 sends a message to relay nodes via broadcast channels, and the relay nodes receive and forward the message to neighboring relay nodes so that it is delivered to the destination device 400.

The flooding technique uses a broadcast channel to receive and retransmit messages, thus extending the transmission range of messages.

A mesh network using the flooding technique is a dynamic network. In the mesh network using the flooding technique, a device can receive and transmit (or retransmit) a message at any time as long as its density allows it.

The flooding technique is easy to implement, but may have extensibility issues arising from an extended network because messages are sent directionlessly.

That is, in the mesh network using the flooding technique, when a device sends a message, multiple devices receive the message and forward the received message to other devices.

Unlike the routing technique, the flooding technique enables the transfer of a message easily without the cost of constructing a routing table, but increases network traffic because all relay devices that receive the message retransmit it.

To avoid this, the number of devices on the mesh network may be adjusted between 100 and 1,000, and the exact number of devices may be determined by a number of factors.

For example, the number of devices may be determined by network capacity, traffic loads of data sources, network latency and reliability requirements.

In the present specification, the hop refers to a link between devices in the Bluetooth mesh network. That is, a link established between a source device and a relay device, a link established between relay devices, a link established between a relay device and a destination device and a link established between a source device and a destination device may be called hops.

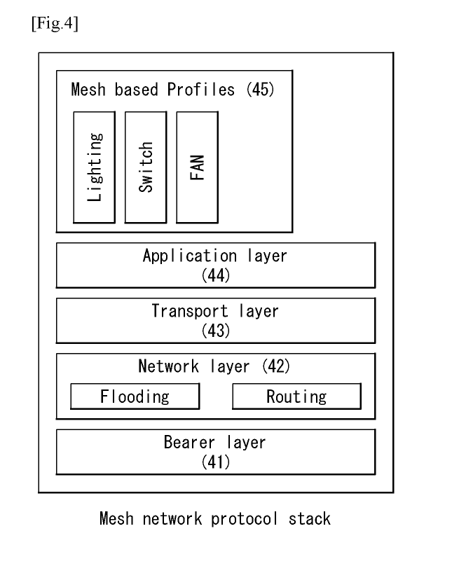

FIG. 4 illustrates an example of a protocol stack of the Bluetooth mesh network to which the present invention is applicable.

Referring to FIG. 4, the protocol stack of the mesh network includes a bearer layer 41, a network layer 42, a transport layer 43, an application layer 44 and mesh network based profiles.

The bearer layer 41 defines a method for a message to be transmitted between nodes in the Bluetooth mesh network. That is, in the mesh network, the bearer where a message is transmitted is determined.

An advertising bearer and a GATT bearer are existed in the mesh network for transmitting a message.

The network layer 42 is a layer for forwarding a message through an address of a source node for transmitting a message or an address of a destination node to which a message is to be forwarded, and defines a method for a node to receive a message and to retransmit it to neighboring nodes again and the formats of messages.

The message transmission method defined in the network layer 42 may include the flooding technique, the routing technique, and so on as described above.

In addition, the network layer 42 defines whether a message is relayed or forwarded and a method for authenticating and encoding network messages.

The transport layer 43 is a layer for defining the encryption and authentication of the application data by providing the confidentiality of an application message, and encodes the data transmitted from the application layer 44 with an application key and forwards it the network layer 42.

The application layer 44 defines a packet format of a message so as to use a defined operation code (Opcode) and parameters.

The mesh based profile 45 defines the profiles that may be provided in the Bluetooth mesh network.

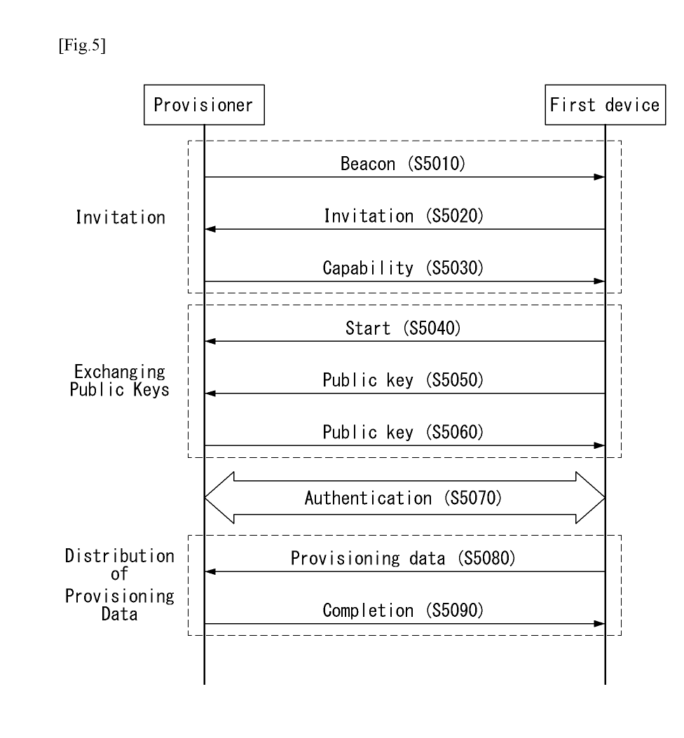

FIG. 5 is a flowchart illustrating an example of a method through which a device joins in a Bluetooth mesh network to which the present invention is applicable.

A new device or a device which is not provisioned should go through a provisioning procedure in order to operate by being joined in a mesh network.

The provisioning procedure means a procedure of authenticating the device which is not authenticated, and providing the basic information (e.g., Unicast Address, all types of keys, etc.) for participating in the mesh network.

That is, the provisioning procedure is a procedure for a Provisioner in the mesh network to provide the information for participating in the mesh network, and the first device may acquire the address of network, keys and various types of information for operating as a part of device indicators and the mesh network.

The provisioning procedure includes Invitation Step, Exchanging Public Key Step, Authentication Step and Distribution of Provisioning Step.

The provisioning procedure may be performed through various types of bearers. For example, the provisioning procedure may be performed by an advertising-based bearer, a Mesh Provisioning Service-based bearer or a Mesh-based bearer.

The advertising-based bearer is a bear which is essentially established, and in the case that the advertising-based bearer is not supported or the provisioning data is unable to be transmitted through the advertising-based bearer, the Provisioning Service-based bearer or the Mesh-based bearer may be used for the provisioning procedure.

The Provisioning Service-based bearer means a bearer for exchanging the provisioning data through the GATT protocol of the existing Bluetooth LE, and the Mesh-based bearer means a bearer for exchanging the provisioning data through the mesh network in the case that the first device and the second device are existed in the distance for directly exchanging data.

Subsequently, the establishing procedure for the advertising-based bearer will be described.

After the bearer is established between the first device and the second device, the first device may be provisioned through the provisioning procedure below.

Invitation Step

The invitation step is started while the second device scans the first device. The first device transmits a beacon message to the second device (step, S5010). The beacon message includes a UUID of the first device.

The second device that scans the first device through the beacon message transmits an Invitation message to the first device (step, S5020).

The invitation message is a message for asking whether the first device performs the provisioning procedure. In the case that the first device does not want to perform the provisioning procedure, the first device ignores the invitation message.

However, in the case that the first device wants to perform the provisioning procedure, that is, to participate in the mesh network, the first device transmits a capability message in response to it (step, S5030).

The capability message may include the information that represents whether the first device supports a security algorithm configuration, a Public Key, the information on whether to output a value to a user, the information on whether to receive an input value from a user, and so on.

Exchanging Public Key Step

Later, the second device transmits a start message for starting the provisioning to the first device (step, S5040).

In the case of being unable to use the Public Key using an out of band technology, the first device and the second device exchange the Public Keys (steps, S8050 and S8060).

However, in the case of being able to use the Public Key using the out of band technology, the second device transmits an ephemeral public key to the first device, and read a static public key using the out of band technology from the first device.

Later, the second device authenticates the first device by performing the authentication procedure with the first device (step, S5070).

Distribution of Provisioning Data Step

When the first device is authenticated, the second device and the first device calculate and generate a session key.

Later, the second device transmits the provisioning data to the first device (step, S5080).

The provisioning data may include an application key, a device key, a network key, an IV index, a Unicast address, and so on.

The first device that receives the provisioning data transmits a completion message in response to it, and the provisioning procedure is ended (step, S5090).

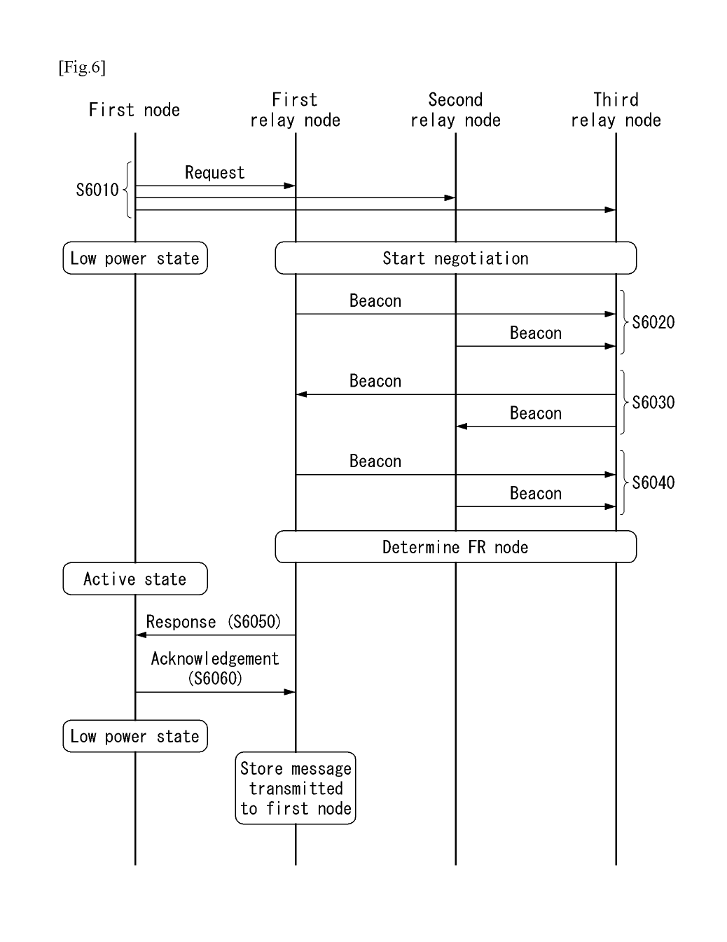

FIG. 6 is a flowchart illustrating an example of a method for forming a friendship relationship between an edge node and a relay node in a Bluetooth mesh network to which the present invention is applicable.

Referring to FIG. 6, the edge node may be generally provided with power through a battery, and may be in a sleep state normally and wake up according to an interaction or periodically.

Specifically, a low power node (referred to hereinafter as LPN) provided with power through a battery, such as the edge node, periodically switches to a low power state (or sleep state) in which a message is not transmitted and received in order to reduce power consumption.

In such low power state, the LPN cannot continuously scan mesh packets and beacons transmitted from neighboring nodes and thus may not receive important messages transmitted from neighbor nodes or message for update.

To solve such a problem, a specific relationship needs to be formed between the LPN and a specific relay node.

That is, a relationship in which the relay node receives and stores messages transmitted to the LPN in place of the LPN while the LPN is in a low power state and sends the stored messages to the LPN when the LPN switches from the low power state to a state in which the LPN can transmit and receive messages (e.g., active state) needs to be formed between the LPN and the relay node.

Hereinafter, the specific relationship between the LPN and the relay node is referred to as a friendship relationship and a node having a friendship relationship with the LPN is referred to as an FR (Friend Relay) node.

To build a friendship relationship, a first node corresponding to an LPN transmits a request message for requesting establishment of a friendship relationship to neighbor relay nodes (e.g., first, second and third relay nodes) within a distance of one hop from the first node (S6010).

The request message may include a network address used by the first node in the mesh network and friendship parameters that the first node desires.

Friendship parameters may include the following parameters.
Friend Update Window (FUW)=two-byte number representing the number of milliseconds that the LPN stays awake, waiting for an update response from the FR. The LPN goes back to sleep if this time has passed without receiving any packet from the FR.
Friend Ack Interval (FAI)=two-byte number representing the number of milliseconds between the moment when the LPN sends a message to another device with the FUT bit set and the moment when it wakes up to listen for a response from that device. With this value, the FR knows the exact moment that the LPN is listening for responses and ACKs.
Friend Update Request Timeout (FURT)=two-byte number representing the number of milliseconds between two consecutive update requests. If the LPN does not send a new update request within this interval, the FR may consider the friendship lost and clear the associated cache. This happens, for instance, when the LPN is mobile and has relocated in another part of the network.

The first node enters a low power state in which the first node does not transmit and receive message to reduce power consumption upon transmission of the request message, and the first, second and third relay nodes start to negotiate which node will establish a friendship relationship with the first node upon reception of the request message.

Upon reception of the request message from the first node, the relay nodes periodically transmit beacons including their network addresses, the address of the first node and parameter values for determining a node which will establish a friendship relationship with the first node.

The parameter values for determining a node which will establish a friendship relationship with the first node may include various types of information for recognizing relay node capabilities, such as information on available caches, received signal strength indication and FUW.

When a parameter value included in a beacon is greater than a parameter value of a relay node that has received the beacon, the relay node includes the received parameter value in a beacon and sends the beacon to neighbor relay nodes. A relay node having the parameter value included in the beacon finally establishes a friendship relationship with the first node.

Specifically, the first relay node and the second relay node respectively transmit beacon messages including their parameter values to the third relay node (S6020), as illustrated in FIG. 6.

The third relay node compares the parameter values received from the first relay node and the second relay node with the parameter value thereof, includes a largest parameter value in a beacon message and sends the beacon message to the first relay node and the second relay node (S6030).

The following description will be based on the assumption that the first relay node has the largest parameter value.

Upon reception of the beacon message from the third relay node, the first relay node and the second relay node compare the parameter value included in the received beacon message with the parameter value thereof, includes a larger parameter value in a beacon message and sends the beacon message to the third relay node (S6040).

Through steps S6020 to S6040, each relay node compares the parameter value thereof with parameter values of other relay nodes until the first node enters an active state and the first relay node having the largest parameter value is determined as an FR node having a friendship relationship with the first node.

Then, the first relay node determined as an FR node transmits a response message including the parameter value thereof to the first node when the first node enters an active state, and the first node sends an acknowledgement message to the first relay node in response to the response message (S6050 and S6060).

Upon confirmation of determination of the FR node, the first node enters a low power state to reduce power consumption and the first relay node determined as the FR node stores messages transmitted to the first node, that is, messages having the address of the first node as a destination address.

If a request message for requesting transmission of stored messages is not sent from the first node for a time set by the FUW parameter, the first relay node deletes the stored messages.

Through this method, a friendship relationship is established between an edge node and a relay node.

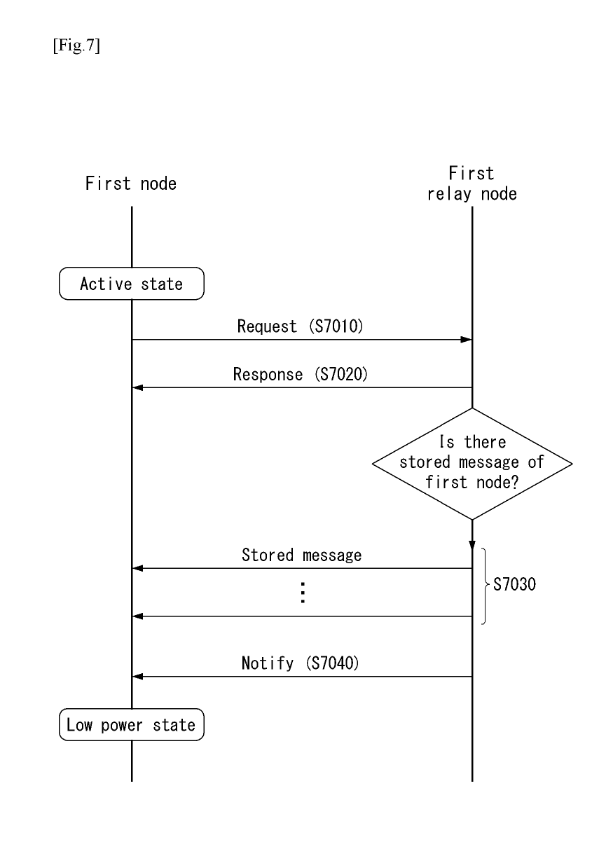

FIG. 7 is a flowchart illustrating an example of a method for transmitting and receiving messages between an edge node and a relay node having a friendship relationship therebetween to which the present invention is applicable.

Referring to FIG. 7, the first relay node having a friendship relationship with the first node corresponding to an LPN, as described with reference to FIG. 6, stores messages transmitted to the first node when the first node enters a low power state and sends the stored messages to the first node when the first node enters an active state.

Specifically, when the first node is in a low power state, the first relay node having a friendship relationship described with reference to FIG. 6 with the first node receives messages transmitted to the first node and stores the messages.

Then, the first node periodically wakes up from the low power state and enters an active state and transmits, to the first relay node, a request message for requesting transmission of the messages transmitted thereto in the low power state (S7010).

Upon reception of the request message for requesting transmission of the stored messages from the first node, the first relay node sends a response message including the number MsgCount of stored messages in response to the request message (S7020).

When there is no stored message, that is, the number MsgCount is 0, the first relay node does not transmit any message to the first node because there is no message to be transmitted and the first node enters a low power state again.

However, when there is a message to be transmitted to the first node, that is, the number MsgCount is equal to or greater than 1, the first relay node transmits the stored message to the first node (S7030).

Upon transmission of all stored messages, the first relay node notifies the first node that all stored messages have been transmitted by sending a notification message in which the number MsgCount is set to “0” (S7040).

Upon reception of the notification message indicating that all stored messages have been transmitted from the first relay node, the first node enters a low power state to reduce power consumption.

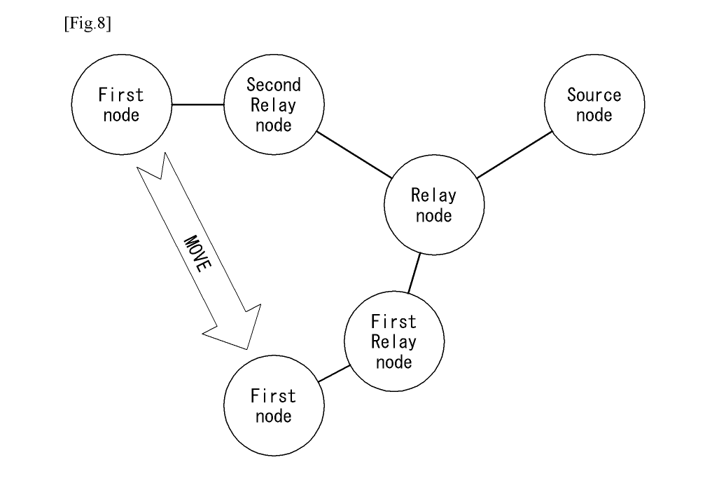

FIG. 8 illustrates an example in which an edge node in a friendship relationship in a Bluetooth mesh network moves to which the present invention is applicable.

Referring to FIG. 8, when the first node corresponding to an LPN moves by a distance (one hop or more) within which the first node cannot transmit a message to the second relay node after establishment of a friendship relationship with the second relay node, the first node and the second relay node cannot directly transmit and receive messages any more.

Accordingly, the first node establishes a friendship relationship with the first relay node through the procedure described above with reference to FIG. 6.

However, even when a new friendship relationship is established between the first node and the first relay node, the second relay node cannot be aware of establishment of a friendship relationship between the first node and the first relay node because the second relay node is not notified of establishment of a friendship relationship between the first node and the first relay node.

Accordingly, the second relay node continuously stores messages transmitted to the first node without deleting the messages for a set time according to the friendship relationship previously established therebetween, generating a problem of increased power consumption of the second relay node.

In addition, the second relay node deletes all messages transmitted to the first node after lapse of the set time, and thus the first node needs to wait until the messages deleted by the second relay node are re-transmitted, generating a problem of increased message transmission delay time.

Accordingly, to solve such problems, the present invention proposes a method through which a relay node currently having a friendship relationship with an LPN receives stored messages from a relay node previously having a friendship relationship with the LPN and transmits the messages to the LPN when the location of the LPN is changed.

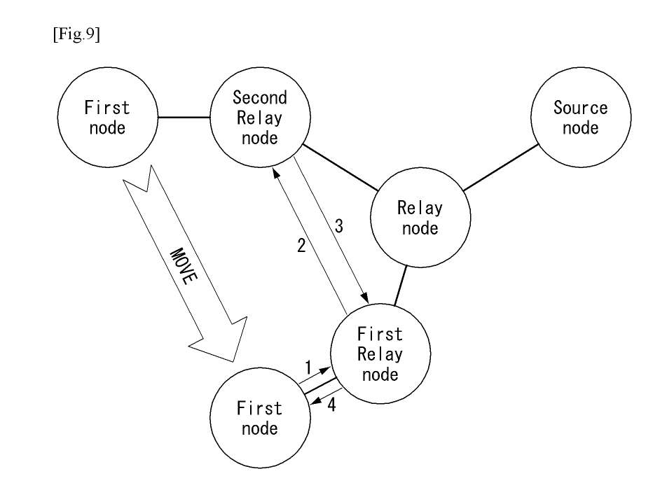

FIG. 9 illustrates an example of a method through which an edge node having a friendship relationship in a Bluetooth mesh network transmits/receives messages to/from a relay node having a new friendship relationship with the edge node to which the present invention is applicable.

Referring to FIG. 9, when the first node corresponding to an LPN moves and establishes a new friendship relationship with the first relay node, the first relay node having a new friendship relationship with the first node can receive messages sent to the first node from the second relay node having a previous friendship relationship with the first node and transmit the received messages to the first node.

Specifically, 1, when the first node having a friendship relationship with the second relay node moves and establishes a new friendship relationship with the first relay node, the first node transmits information of the second relay node (e.g., a network address used by the second relay node in the mesh network and the like) to the first relay node.

2. The first relay node transmits a request message for requesting deletion and transmission of messages related to the first node to the second relay node on the basis of the network address received from the first node.

Here, the messages related to the first node may refer to messages having the address of the first node as a destination address or messages related to security update of the first node.

3. The second relay node sends the messages related to the first node to the first relay node and deletes the stored messages related to the first node.

Specifically, the second relay node transmits messages defined to be transmittable between relay nodes in the application layer to the first relay node and deletes all stored messages related to the first node.

4. The first relay node sends, to the first node, messages received from the second relay node and messages stored therein and related to the first node upon reception of a request for transmission of stored messages from the first node.

Through this method, the LPN can receive messages stored in a previous friend relay node even when the LPN moves and thus a relay node having a friendship relationship with the LPN is changed.

Furthermore, a relay node can reduce power consumption by deleting messages related to the LPN having a friendship relationship therewith without storing the messages when the LPN moves and establishes a friendship relationship with a new relay node.

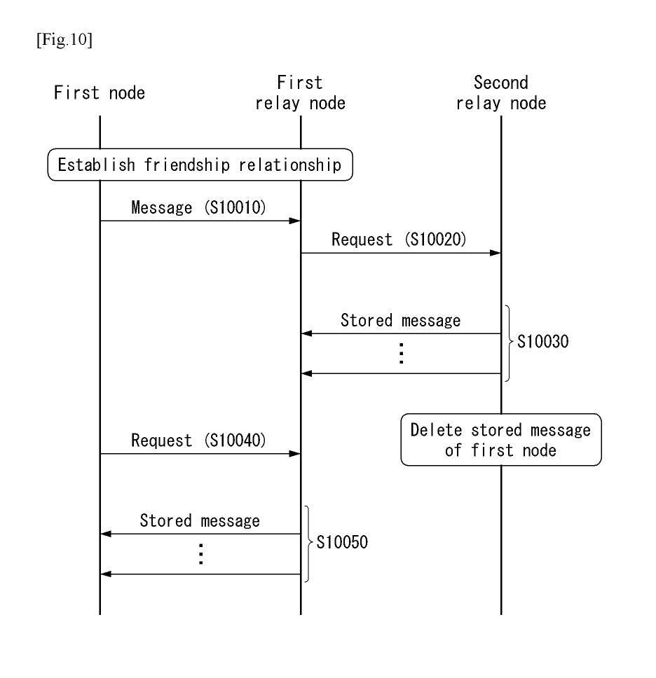

FIG. 10 is a flowchart illustrating an example of a method through which a node receives a message, which is transmitted when the node is in a low power state, through a relay node in a Bluetooth mesh network to which the present invention is applicable.

Referring to FIG. 10, when an LPN corresponding to an edge node having a friendship relationship with a relay node in the Bluetooth mesh network moves, a relay node that establishes a new friendship relationship with the LPN may receive messages related to the LPN and stored in the previous relay node and send the messages to the LPN.

Specifically, the first node corresponding to an LPN establishes a friendship relationship with the second relay node, as described above, and then moves and builds a new friendship relationship with the first relay node.

Upon completion of establishment of a friendship relationship with the first relay node, the first node sends, to the first relay node, a message (first message) including information of the second relay node having a previous friendship relationship therewith (S10010).

The information of the second relay node, transmitted by the first node, includes information such as a network address (first network address) of the second relay node to identify the second relay node.

Upon recognition of the second relay node through the network address of the second relay node, the first relay node may notify the second relay node that the first relay node has established a friendship relationship with the first node by sending a request message (first request message) to the second relay node (S10020).

In addition, the first relay node may request transmission and deletion of messages related to the first node stored in the second relay node through the request message.

Here, the request message may include an identifier (e.g., UUID) for identifying the first node and an identifier (e.g., network address (second network address)) for identifying the first relay node.

The second relay node sends the messages related to the first node and stored therein to the first relay node and deletes the messages related to the first node at the request of the first relay node (S10030).

Specifically, the second relay node sends messages defined to be transmittable between relay nodes in the application layer to the first relay node and deletes all stored messages related to the first node.

For example, a message such as a ping for calculating the number of hops between nodes can be deleted instead of being sent to the first relay node according to determination of the application layer.

Here, there may be two methods through which the second relay node transmits stored messages related to the first node to the first relay node.

Firstly, stored messages related to the first node can be transmitted to the first relay node as they are. In this case, however, part of or all messages may be dropped by a relay node (e.g., first relay node) during transmission.

Secondly, the second relay node can modify the stored messages related to the first node into a binary blob structure defined in Bluetooth Core Specification, include the blob structure in a payload and send the payload to the first relay node.

When the second method is used, possibility that data is lost halfway through transmission decreases because a large volume of data is divided and transmitted multiple times.

The relay node receives and stores not only the messages related to the first node but also messages transmitted to the first node when the first node is in a low power state.

Thereafter, the first node switches from the low power state to an active state and sends, to the first relay node, a request message (second request message) for requesting transmission of messages transmitted to the first node while the first node is in the low power state (S10040).

Here, the second request message may be called a friendship update message.

Upon reception of the request message from the first node, the first relay node sends, to the first node, not only messages received from the second relay node and stored therein but also messages transmitted to the first node (S10050).

Through this method, the LPN can receive messages stored in a relay node having a previous friendship relationship with the LPN even when the LPN moves and establishes a new friendship relationship with a new relay node.

FIG. 1i is a flowchart illustrating an example of a method through which a node receives messages, which are transmitted when the node is in a low power state, through a relay node in a Bluetooth mesh network to which the present invention is applicable.

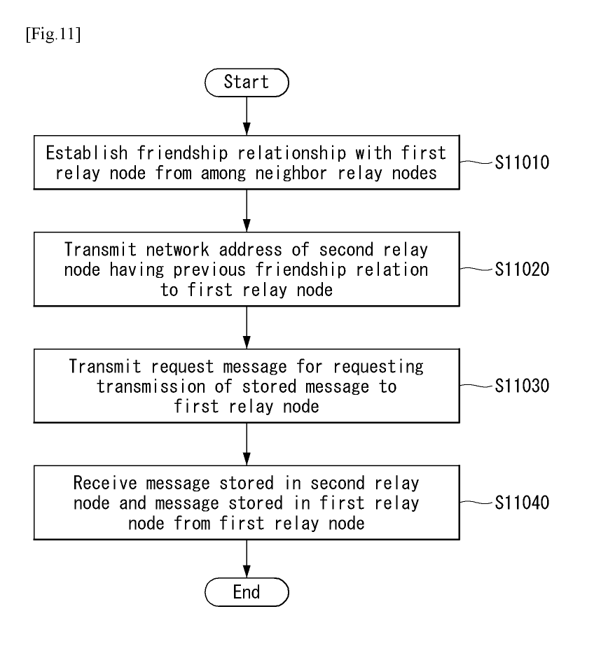

Referring to FIG. 11, when an LPN corresponding to an edge node moves in the Bluetooth mesh network, the LPN may receive messages stored in a relay node having a previous friendship relationship with the LPN through a relay node having a new friendship relationship with the LPN.

As described above, a friendship relationship refers to a relationship in which a relay node stores messages sent to an LPN when the LPN enters a low power state in which the LPN cannot transmit and receive messages and then transmits the stored messages to the LPN when the LPN enters an active state in which the LPN can transmit and receive messages.

The LPN is in a lower power state and periodically enters an active state.

Specifically, the first node corresponding to an LPN having a friendship relationship (first specific relationship) described above with the second relay node may establish a friendship relationship (second specific relationship) with a neighbor relay node present within a distance of one hop when the first node moves by a distance within which the first node cannot transmit/receive messages to/from the second relay node (S11010).

Upon completion of establishment of a friendship relationship with the first relay node, the first node sends a message (first message) including information of the second relay node having a previous friendship relationship to the first relay node (S11020).

The information of the second relay node transmitted by the first node includes information such as the network address (first network address) of the second relay node for identifying the second relay node in the Bluetooth mesh network.

The first node having a friendship relationship with the first relay node enters a low power state to reduce power consumption.

Thereafter, the first node periodically enters an active state and sends, to the first relay node, a request message for requesting transmission of messages transmitted to the first node while the first node is in the low power state (S11030).

Here, the request message may be called a friendship update message.

The first node may receive, from the first relay node, not only messages stored in the second relay node but also messages transmitted to the first node and stored in the first relay node after the first node establishes a friendship relationship with the first relay node (S11040).

The messages stored in the second relay node and transmitted to the first node through the first relay node may be messages defined to be transmittable between relay nodes in the application layer as described with reference to FIG. 10.

According to this method, the first node can receive messages stored in a relay node having a previous friendship relationship therewith even when the first node establishes a new friendship relationship with a relay node, and thus important messages can be sent to the first node without being dropped and a time required for retransmission due to omission of important messages can be reduced.

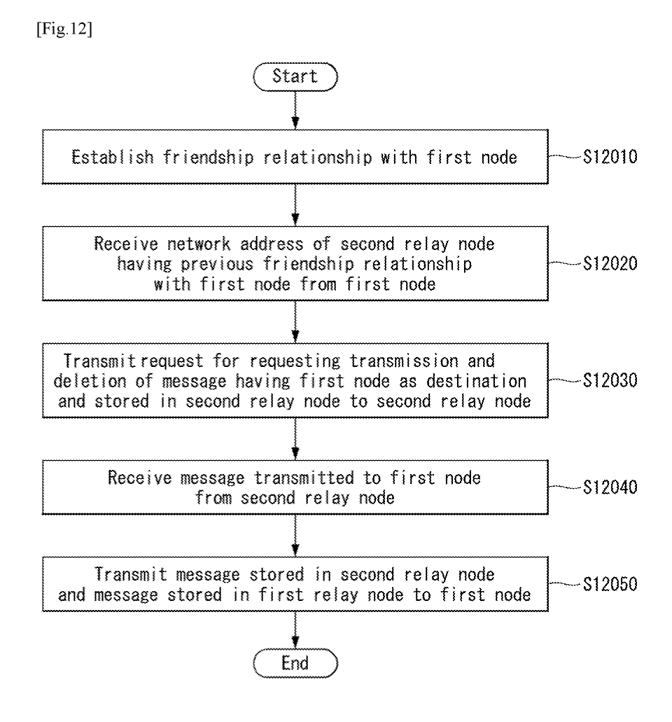

FIG. 12 is a flowchart illustrating an example of a method through which a relay node stores messages transmitted to a node when the node is in a low power state in a Bluetooth mesh network to which the present invention is applicable.

Referring to FIG. 12, when a relay node establishes a friendship relationship with an LPN corresponding to an edge node in the Bluetooth mesh network and a relay node having a previous friendship relationship with the LPN is present, the relay node may receive messages stored in the relay node having the previous friendship relationship with the LPN and send the messages to the LPN.

As described above, a friendship relationship refers to a relationship in which a relay node stores messages sent to an LPN when the LPN enters a low power state in which the LPN cannot transmit and receive messages and then transmits the stored messages to the LPN when the LPN enters an active state in which the LPN can transmit and receive messages.

The LPN is in a low power state and periodically enters an active state.

Specifically, the first relay node establishes the aforementioned friendship relationship (first specific relationship) with the first node corresponding to an LPN located within a distance of one hop (S12010).

Upon completion of the friendship relationship with the first node, the first relay node receives, from the first node, a message (first message) including information of the second relay node having a previous friendship relationship with the first node (S12020).

The information of the second relay node, transmitted from the first node, includes information such as the network address (first network address) of the second relay node for identifying the second relay node in the Bluetooth mesh network.

Upon recognition of the second relay node through the network address of the second relay node, the first relay node may notify the second relay node that the first relay node has established a friendship relationship with the first node by sending a request message (first request message) to the second relay node (S12030).

Furthermore, the first relay node may request transmission and deletion of messages related to the first node and stored in the second relay node through the request message.

Here, the request message may include an identifier (e.g., UUID) for identifying the first node and an identifier (e.g., network address (second network address)) for identifying the first relay node.

The first relay node may receive, from the second relay node, messages related to the first node and stored in the second relay node (S12040).

Specifically, the first relay node may receive, from the second relay node, messages defined to be transmittable between relay nodes in the application layer.

For example, a method such as a ping for calculating the number of hops between nodes may not be transmitted from the second relay node according to determination of the application layer.

Here, one of the two methods described above with reference to FIG. 10 can be used as a method for receiving messages related to the first node from the second relay node.

When the first node is in a low power state, the first relay node receives and stores messages related to the first node and transmitted from the second relay node but also messages sent to the first node.

When the first node switches from the low power state to an active state, the first relay node receives, from the first node, a request message (second request message) for requesting transmission of messages sent to the first node while the first node is in the low power state.

Here, the second request message may be called a friendship update message.

Upon reception of the request message from the first node, the first relay node sends not only the messages received from the second relay node and stored therein but also messages transmitted to the first node (S12050).

According to the method for transmitting and receiving data in the Bluetooth mesh network according to an embodiment of the present invention, a node can transmit and receive data through one or more relay nodes.

Furthermore, according to the present invention, a relay node can store messages transmitted to an edge node while the edge node is in a low power state in the Bluetooth LE mesh network.

In addition, according to the present invention, a current relay node can receive, from a previous relay node, messages transmitted to the edge node and stored in the previous relay node and send the messages to the edge node when the location of the edge node is changed while the edge node is in a low power state.

Further, according to the present invention, the current relay node can receive messages related to the edge node from the previous relay node and send the messages to the edge node. Accordingly, the messages stored in the previous relay node can be transmitted to the edge node and thus retransmission of the messages can be prevented.

In addition, according to the present invention, when the location of the edge node is changed in the Bluetooth LE mesh network, messages transmitted to the edge node and stored in the previous relay node are sent to the current relay node and then deleted, and thus there is no need to store the messages transmitted to the edge node for a long time.

Moreover, according to the present invention, since the previous relay node need not store the messages transmitted to the edge node for a long time, power consumption of the previous relay node can be reduced.

Technical tasks obtainable from the present invention are non-limited by the above-mentioned technical tasks and other unmentioned technical tasks can be clearly understood from the following description by those having ordinary skill in the technical field to which the present invention pertains.

Although the description of the present invention is explained with reference to each of the accompanying drawings for clarity, it is possible to design new embodiments by merging the embodiments shown in the accompanying drawings. If a recording medium readable by a computer, in which programs for executing the embodiments mentioned in the foregoing description are recorded, is designed in necessity of those skilled in the art, it may be within the scope of the appended claims and their equivalents.

The method and apparatus for transmitting and receiving data in a mesh network using Bluetooth according to the present specification may be non-limited by the configurations and methods of the embodiments mentioned in the foregoing description. The embodiments mentioned in the foregoing description may be configured in a manner of being selectively combined with one another entirely or in part to enable various modifications.

In addition, the method and apparatus for transmitting and receiving data in a mesh network using Bluetooth according to the present invention may be implemented with processor-readable code in a processor-readable recording medium provided to a network device. The processor-readable medium may include all kinds of recording devices capable of storing data readable by a processor. The processor-readable medium may include one of ROM, RAM, CD-ROM, magnetic tapes, floppy disks, optical data storage devices, and the like and may also include a carrier-wave type implementation such as transmission via the Internet. Furthermore, as the processor-readable recording medium is distributed to a computer system connected via a network, processor-readable code may be saved and executed in a distributive manner.

It will be appreciated by those skilled in the art that various modifications and variations may be made in the present invention without departing from the spirit or scope of the invention. Thus, it is intended that the present invention cover the modifications and variations of this invention provided they come within the scope of the appended claims and their equivalents.

Both apparatus and method inventions are mentioned in this specification and descriptions of both of the apparatus and method inventions may be complementarily applied to each other.

What is claimed is:

1. A method for transmitting and receiving data by a first node in a Bluetooth mesh network, comprising:
establishing a first specific relationship with a first relay node,
wherein the first specific relationship indicates a relationship in which the first relay node receives and stores messages transmitted to the first node, when the first node is in a low power state;
transmitting, to the first relay node, a first message including a network address of a second relay node that has established a second specific relationship with the first node before the first specific relationship is established,
wherein the second specific relationship indicates a relationship in which the second relay node receives and stores messages transmitted to the first node, when the first node is in the lower power state; and
receiving at least one message stored in the second relay node from the first relay node in an active state,
wherein the at least one message is a message stored in the second relay node while the first node maintains the second specific relationship with the second relay node.

2. The method of claim 1, wherein a destination of the at least one message is set to the first node.

3. The method of claim 1, wherein the step of establishing of the first specific relationship comprises:
transmitting a request message for requesting establishment of the first specific relationship to the first relay node and neighbor relay nodes;
receiving, from the first relay node, a response message indicating that the first relay node among the first relay node and the neighbor relay nodes has been determined as a node for establishing the first specific relationship; and
transmitting, to the first relay node, an acknowledgement message including a group address of a group including the first node.

4. The method of claim 1, further comprising:
transmitting, to the first relay node, a request message for requesting transmission of one or more messages having the address of the first node as a destination address and stored in the first relay node in an active state; and
receiving the one or more messages from the first relay node.

5. The method of claim 4, wherein the request message includes an update time parameter indicating duration of the active state.

6. The method of claim 1, wherein the low power state indicates a state in which the first node does not transmit and receive messages, and
wherein the active state indicates a state in which the first node transmits and receives message.

7. The method of claim 1, wherein the first node periodically switches from the low power state to the active state.

8. A method for transmitting/receiving, by a first relay node, data to/from a first relay node and a first node in a Bluetooth mesh network, comprising:
establishing a first specific relationship with the first node,
wherein the first specific relationship indicates a relationship in which the first relay node receives and stores messages transmitted to the first node when the first node is in a low power state;
receiving, from the first node, a first message including a first network address of a second relay node that has established a second specific relationship with the first node before the first specific relationship is established,
wherein the second specific relationship indicates a relationship in which the second relay node receives and stores messages transmitted to the first node, when the first node is in the lower power state;
transmitting, to the second relay node, a request message for requesting transmission and deletion of at least one message stored in the second relay node;
receiving the at least one message from the second relay node; and
transmitting the at least one message to the first node,
wherein the request message includes an identifier for identifying the first node and a second network address of the first relay node, and
wherein a destination of the at least one message is set to the address of the first node.

9. The method of claim 8, wherein the step of establishing of the first specific relationship comprises:
receiving, from the first node, a first request message for requesting establishment of the first specific relationship;
transmitting a second message to neighbor relay nodes adjacent to the first node,
wherein the second message includes first parameter information for determining a node for establishing the first specific relationship;
receiving a third message from each of the neighbor relay nodes,
wherein the third message includes second parameter information for determining the node for establishing the first specific relationship;
comparing the first parameter information with the second parameter information;
transmitting, to the first node, a response message indicating that the first relay node is determined to be a node for establishing the first specific relationship from among the first relay node and the neighbor relay nodes, when the first relay node is determined to be the node for establishing the first specific relationship as a comparison result; and
receiving, from the first node, an acknowledgement message including a group address of a group including the first node.

10. The method of claim 9,
wherein the first parameter information includes at least one of first cache information indicating an available cache of the first relay node, a first received signal strength indication (RSSI) of the first relay node or a first time parameter indicating a time for which messages are transmittable from the first relay node to the first node, and
wherein the second parameter information includes at least one of second cache information indicating an available cache of each of the neighbor relay nodes, a second RSSI of each of the neighbor relay nodes or a second time parameter indicating a time for which messages are transmittable from each of the neighbor relay nodes to the first node.

11. The method of claim 9, wherein the response message includes the first parameter information.

12. The method of claim 8, further comprising:
receiving one or more messages transmitted to the first node, when the first node is in a low power state;
storing the one or more messages;
receiving, from the first node, a second request message for requesting transmission of the one or more messages;
transmitting the one or more messages to the first node; and
deleting the one or more messages.

13. A first node for transmitting and receiving messages in a Bluetooth mesh network, comprising:
a communication unit for communicating with the outside in a wireless or wired manner; and
a processor functionally connected with the communication unit,
wherein the processor is configured:
to establish a first specific relationship with a first relay node, wherein the first specific relationship indicates a relationship in which the first relay node receives and stores messages transmitted to the first node when the first node is in a low power state;
to transmit, to the first relay node, a first message including a network address of a second relay node that has established a second specific relationship with the first node before the first specific relationship is established, wherein the second specific relationship indicates a relationship in which the second relay node receives and stores messages transmitted to the first node when the first node is in the lower power state; and
to receive at least one message stored in the second relay node from the first relay node in an active state,
wherein the at least one message is a message stored in the second relay node while the first node maintains the second specific relationship with the second relay node.
